(19) United States
(12) Patent Application Publication
(10) Pub. No.: US 2006/0092916 A1
(43) Pub. Date: May 4, 2006

(54) Routing frames in an IP sonet ring using an IP proxy server

(75) Inventors: David S. Harmon, Plano, TX (US); Kevin J. Corley, McKinney, TX (US)

Correspondence Address: BAKER BOTTS L.L.P., 2001 ROSS AVENUE, SUITE 600, DALLAS, TX, 75201-2980, US

(73) Assignee: Fujitsu Network Communications, Inc.

(21) Appl. No.: 10/976,501

(22) Filed: Oct. 29, 2004

(51) Int. Cl. H04L 12/66

(52) U.S. Cl. 370/352; 370/404

(57) ABSTRACT

Routing frames in a communication ring includes receiving an invitation at a proxy server of a node of a ring. The invitation indicates that a first endpoint is initiating a call to a second endpoint. An access device operable to communicate the call to the second endpoint is identified. The access device has a private network identifier uniquely identifying the access device within the ring. A media path to the access device is reserved. The private network identifier is inserted into frames received from the first endpoint in order to route the frames to the second endpoint through the media path.

### TECHNICAL FIELD

This invention relates generally to the field of communications and more specifically to routing frames in an IP SONET ring using an IP proxy server.

### BACKGROUND

A communication network for a geographical area, such as a metropolitan area, may have a ring topology. As an example, a synchronous optical network (SONET) transmission system may include a ring having nodes. A node of the ring may send packets through the ring to a destination node. The destination node accepts the packets, while the other nodes ignore the packets.

Known techniques may be used to communicate packets through the ring using Internet Protocol (IP) technology. As an example, Voice over IP (VoIP) technology may be used to communicate voice packets through the ring. Known techniques, however, may be inefficient in certain situations. As an example, point-to-point SONET Ethernet technology typically uses IP resources external to the ring to route the packets. The external IP resources are used even if the call is being routed to another node of the ring. Accordingly, known solutions for communicating packets may be inefficient in certain situations.

### SUMMARY OF THE DISCLOSURE

In accordance with the present invention, disadvantages and problems associated with previous techniques for routing frames may be reduced or eliminated.

According to one embodiment of the present invention, routing frames in a communication ring includes receiving an invitation at a proxy server of a node of a ring. The invitation indicates that a first endpoint is initiating a call to a second endpoint. An access device operable to communicate the call to the second endpoint is identified. The access device has a private network identifier uniquely identifying the access device within the ring. A media path to the access device is reserved. The private network identifier is inserted into frames received from the first endpoint in order to route the frames to the second endpoint through the media path.

Certain embodiments of the invention may provide one or more technical advantages. A technical advantage of one embodiment may be that a node of a ring may route Internet Protocol (IP) packets to another node of the ring. Accordingly, the ring does not need to use external IP resources to route the IP packets.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network that includes a ring for routing packets;

FIGS. 2 through 5 are block diagrams illustrating the network of FIG. 1 routing packets;

FIG. 6 is a block diagram illustrating one embodiment of a proxy server of the ring of FIG. 1; and

FIG. 7 is a call flow diagram illustrating an example method for routing packets using the network of FIG. 1.

### DETAILED DESCRIPTION OF THE DRAWINGS

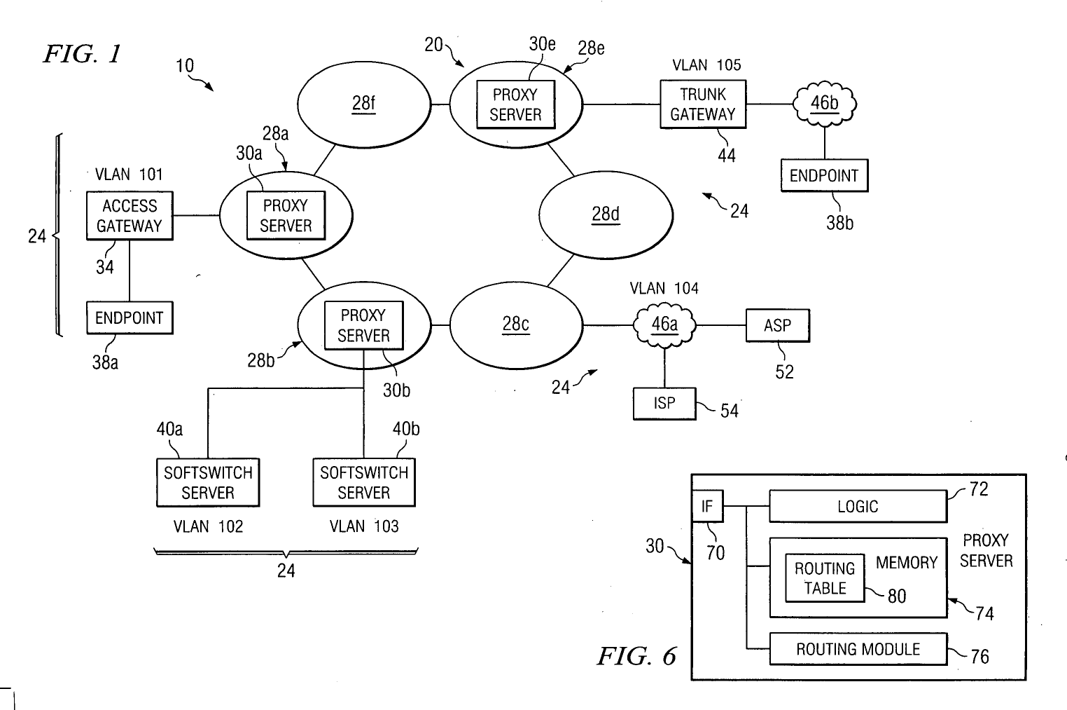

Embodiments of the present invention and its advantages are best understood by referring to FIGS. 1 through 7 of the drawings, like numerals being used for like and corresponding parts of the various drawings.

FIG. 1 is a block diagram illustrating one embodiment of a network 10 that includes a ring 20 for routing packets. According to the embodiment, certain nodes of ring 20 include a proxy server operable to route Internet protocol (IP) packets within ring 20. Accordingly, ring 20 does not need to use external IP devices in order to route IP packets within ring 20.

According to the embodiment, network 10 communicates information in packets. A packet may comprise a bundle of data organized in a specific way for transmission, and a frame may comprise the payload of one or more packets organized in a specific way for transmission. A packet may carry any suitable information such as voice, data, audio, video, multimedia, other information, or any combination of the preceding. According to the embodiment, packets may comprise IP packets may be encapsulated into a resilient packet ring (RPR) media access control (MAC) layer for transport.

Referring to FIG. 1, network 10 includes ring 20 coupled to access devices 24 as shown. A ring may refer to a network of communication devices that has a ring topology. Ring 20 has nodes 28. A node may refer to a point of a ring at which packets may be communicated to, from, or both to and from the ring.

According to one embodiment, ring 20 may comprise an optical fiber ring. For example, ring 20 may comprise a resilient packet ring that includes SONET devices. A resilient packet ring uses transpaths to communicate among nodes 28 of the ring. At each node, traffic that is not destined for a node simply passes through the node, and is not queued at the node. The transpath allows the resilient packet ring to operate as one continuous medium shared by the nodes. Since a packet node does not process transtraffic, a resilient packet ring may scale more easily to higher data rates. Ring 20 may transport packets communicating any suitable traffic, such time division multiplexed (TDM) traffic, and may communicate using any suitable protocol such as the Ethernet over SONET protocol.

Ring 20 may have any suitable features. For example, ring 20 may support a topology discovery procedure, such as the topology discovery procedure defined in Institute for Electrical and Electronics Engineers, Inc. (IEEE) standard 802.17. Each node 28 constructs a topology map that includes information about the location, capabilities, and health of the node 28. Each node 28 broadcasts messages including the information to other nodes 28. The messages may be generated periodically, dynamically in response to a change in the status of a node 28, or both periodically and dynamically.

Ring 20, however, may have any other suitable feature. For example, ring 20 may use statistical multiplexing for aggregation. As another example, ring 20 may use ingress policing, traffic shaping, or traffic management. Ring 20 may also provide different levels of protection or traffic classes.

Access devices 24 may include any suitable device operable to communicate with nodes 28 of ring 20. Certain access devices 24 may communicate packets using any suitable IP technology, such as a media over IP technology. For example, packets may be communicated using a voice, video, or other suitable media over IP technology. Certain access devices 24 may set up calls using any suitable protocol such as Session Initiation Protocol (SIP) or H.323. According to the illustrated embodiment, access devices include an access gateway 34, endpoints 38, softswitch servers 40, a trunk gateway 44, networks 46, an access service provider (ASP) 52, and an Internet service provider (ISP) 54 coupled as shown.

Node 28a is coupled to access gateway 34 and endpoint 38a. Access gateway 34 allows endpoint 38a to communicate with ring 20. A gateway refers to network equipment operable to route, translate, or both route and translate communications. Access gateway 34 may communicate with endpoint 38 using any suitable digital subscriber line technology, that is, xDSL technology.

An endpoint 38 represents any suitable combination or arrangement of logic for providing communication services such as telephony services. Logic may refer to hardware, software, or any combination of hardware and software. Examples of an endpoint 38 include a communication device such as a telephone, a cell phone, a personal digital assistant, a voice appliance, an answering machine, a facsimile machine, a computer, a server, or other device. An endpoint 38 may be coupled to access gateway 34 by an optical network terminal or other customer premises equipment.

Node 28b is coupled to softswitch server 40a and softswitch server 40b. A softswitch server 40 may operate as a gateway between a circuit-switched and a packet-switched network. Softswitch servers 40 may comprise Voice over IP softswitches.

Node 28c is coupled to communication network 46a, application service provider 52, and Internet service provider 54. A communication network allows nodes 28 to communicate with other networks or devices, and may comprise all or a portion of public switched telephone network (PSTN), a public or private data network, a local area network (LAN), a metropolitan area network (MAN), a wide area network (WAN), a global computer network such as the Internet, a wireline or wireless network, a local, regional, or global communication network, an enterprise intranet, other suitable communication link, or any combination of the preceding.

According to the illustrated example, communication network 46a comprises the Internet. Application service provider 52 offers software and other applications to users over the Internet. Internet service provider 54 provides access for customers to the Internet and the worldwide web.

Node 28e is coupled to trunk gateway 44, communication network 46b, and endpoint 38b. Trunk gateway 44 couples ring 20 to communication network 46b, which may comprise a public switched telephone network. Endpoint 38b may comprise an endpoint operable to communicate with communication network 46b.

An access device 24 may have one or more identifiers that uniquely identify the access device 24. Typically, an access device 24 has an identifier that identifies the access device 24 across a global or wide area network. For example, access devices 24 typically have IP addresses. According to one embodiment, an access device 24 may be assigned an identifier that identifies the access device 24 across a local or metropolitan area network, such as over ring 20. For example, an access device 24 may be assigned a private network identifier that identifies the access device 24 over ring 20. The private network identifier may comprise a virtual local area network (VLAN) identifier. According to one embodiment, the termination point of an access device 24 may be assigned the private network identifier.

According to the illustrated embodiment, access gateway 34 is assigned VLAN 101, softswitch server 40a is assigned VLAN 102, softswitch server 40b is assigned VLAN 103, communication network 46a is assigned VLAN 104, and trunk gateway 44 is assigned VLAN 105. According to one embodiment, ports of a given customer may be assigned the same private network identifier, which may be unique to each customer of the same ring 20.

One or more nodes 28 of ring 20 may each have a proxy server 30 that provides control path management. According to one embodiment, a proxy server 30 may route IP packets within ring 20. Accordingly, ring 20 does not need to use external IP devices to route IP packets within ring 20. According to one embodiment, proxy server 30 receives packets sent by a caller endpoint 38 to a callee endpoint 38. Proxy server 30 identifies a node 28 that can route the packets to callee endpoint 38, and reserves a media path to the node 28. A media path may refer to a communication path over which packets carrying any suitable medium may be communicated. Example media paths include voice and video paths. According to one embodiment, the media path may be a real-time transport protocol (RTP) voice path. Proxy server 30 inserts the private network identifier of the node 28 into the frame of the packets to send the packets callee endpoint 38. An example embodiment of proxy server 30 is described in more detail with reference to FIG. 6.

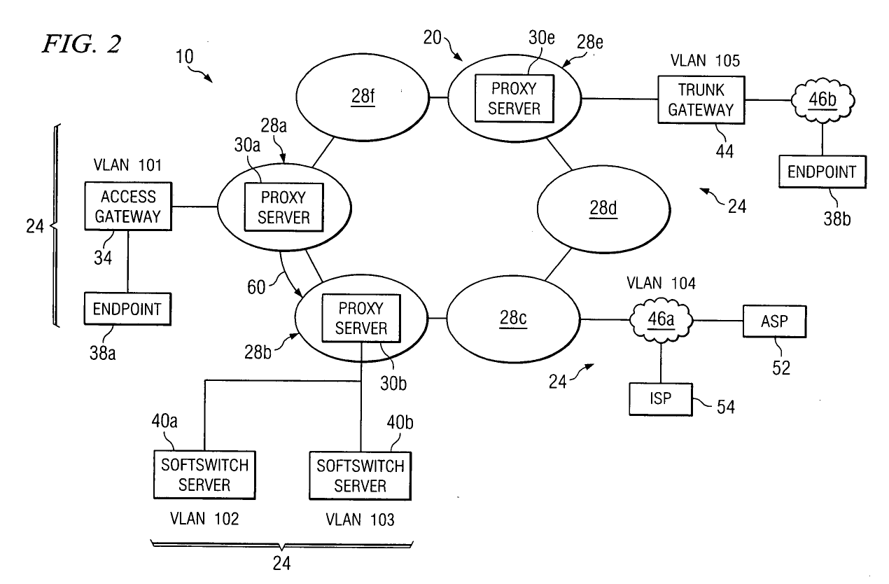

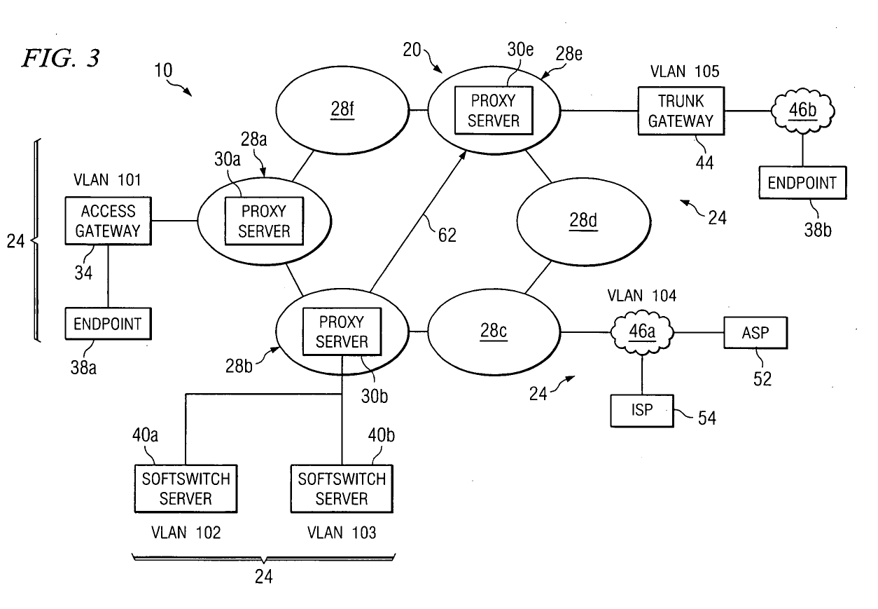

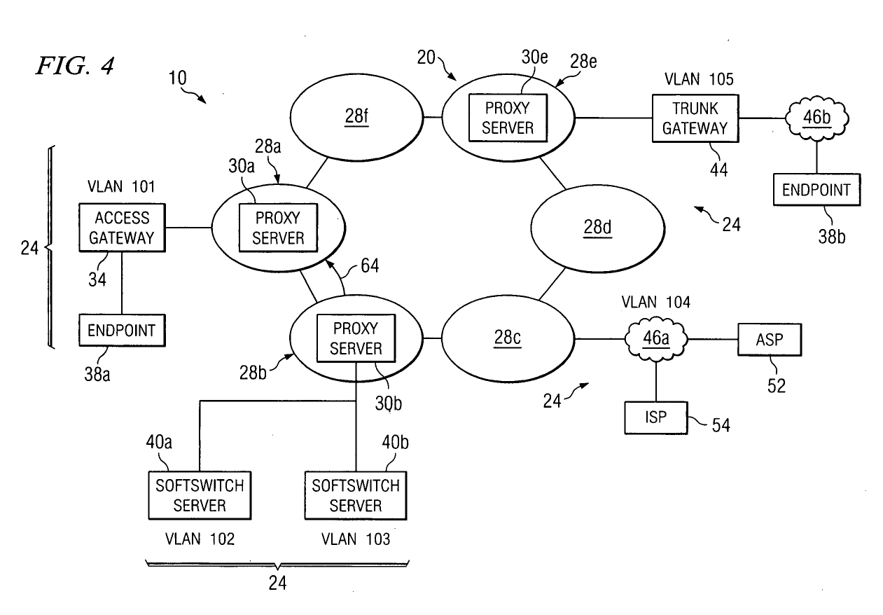

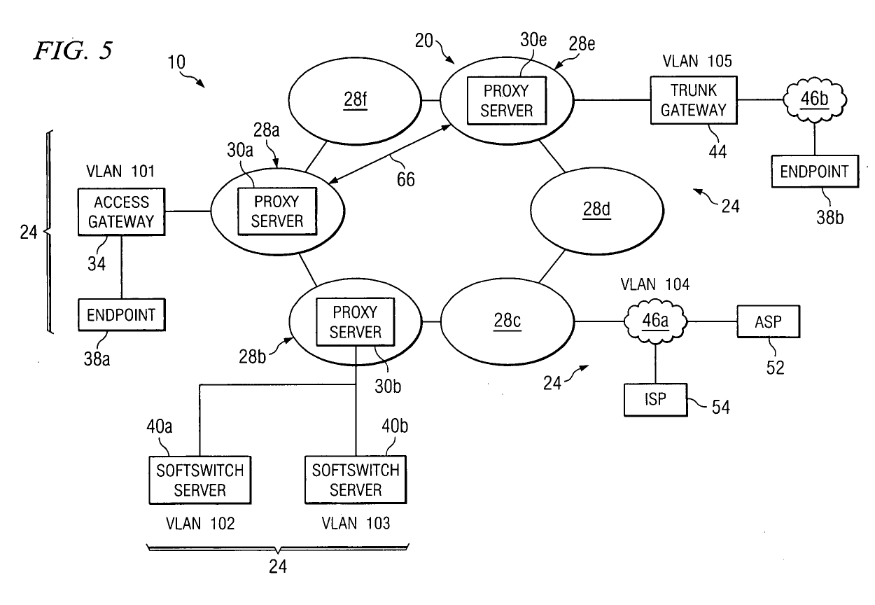

FIGS. 2 through 5 are block diagrams illustrating the network of FIG. 1 routing packets according to an example of operation. Referring to FIG. 2, endpoint 38a places a call to endpoint 38b. Endpoint 38a sends an invite request to proxy server 30a. The invite request is routed to softswitch 40a through proxy server 30b at step 60. Referring to FIG. 3, softswitch 40a reserves a media path to trunk gateway 44 at step 62. Referring to FIG. 4, softswitch 40a sends an invite response to endpoint 38a at step 64. The invite response includes the private network identifier of trunk gateway 44. Referring to FIG. 5, a media path is established between endpoint 38a and endpoint 38b at step 66.

Modifications, additions, or omissions may be made to network 10 without departing from the scope of the invention. Network 10 may include more, fewer, or other components of any suitable arrangement. Additionally, operations of network 10 may be performed using any suitable logic comprising software, hardware, other logic, or any suitable combination of the preceding. As used in this document, “each” refers to each member of a set or each member of a subset of a set.

FIG. 6 is a block diagram illustrating one embodiment of proxy server 30 of FIG. 1. According to one embodiment, proxy server 30 receives packets sent by a caller endpoint 38 to a callee endpoint 38. Proxy server 30 identifies a node 28 that can route the packets to callee endpoint 38, and reserves a media path to the node 28. Proxy server 30 inserts the private network identifier of the node 28 into the frame of the packets to route the packets to callee endpoint 38.

According to the illustrated embodiment, proxy server 30 includes an interface (I/F) 70, logic 72, a memory 74, and one or more modules 76 coupled as shown. Interface 70 receives and sends data, and may comprise, for example, an Ethernet interface. As used in this document, the term “interface” refers to any suitable structure of a device operable to receive input for the device, send output from the device, or both, and may comprise one or more ports. For traffic segregation and security purposes, an interface may allow only frames having identifiers that match the identifiers of a port to be transmitted through the port. The other frames may be dropped.

Logic 72 manages the operation of proxy server 30, and may comprise any suitable hardware, software, or combination of hardware and software. For example, logic 72 may include a processor. As used in this document, the term “processor” refers to any suitable device operable to execute instructions and manipulate data to perform operations.

Memory 74 stores and facilitates retrieval of information used by logic 72, and may include Random Access Memory (RAM), Read Only Memory (ROM), magnetic drives, disk drives, Compact Disk (CD) Drives, Digital Video Disk (DVD) drives, removable media storage, any other suitable data storage device, or a combination of any of the preceding.

Memory 74 stores a routing table 80. Routing table 80 may associate the global network identifier of an access device 24 with the private network identifier of an access device 24, for example, the IP address with the VLAN identifier. Accordingly, routing table 80 allows proxy server 28 to translate between the global network identifier and the private network identifier of an access device 24. For example, routing table 80 may include private network identifiers for VoIP access devices 24. Routing table 80 may be stored in one or more databases, and may be provided to proxy servers 30 during provisioning. Alternatively or additionally, the packets may be dynamically routed using any suitable procedure. For example, the packets may be dynamically routed using an open shortest path first protocol.

Routing module 76 routes packets, and may route IP packets within ring 20. According to one embodiment, proxy server 30 receives packets sent by a caller endpoint 38 to a callee endpoint 38. Routing module 76 identifies a node 28 that can route the packets to callee endpoint 38, and reserves a media path to the node 28. Routing module 76 may identify the node 28 that can route the packets in any suitable manner. For example, routing module 76 may identify the node by forwarding an invite message from caller endpoint 38 to a switch associated with proxy server 30, receiving a progress message from the switch, and identifying the node 28 from a return IP address in the progress message.

Routing module 76 inserts the private network identifier of the node 28 into the frames of the packets to route the packets to callee endpoint 38. The private network identifier may be inserted into frames as a routing tag. A routing tag may include the private network identifier and other information such as an Ethernet type, a class, a priority, other information, or any combination of the preceding. The inserted routing tag may include information that corresponds to the information in the original frame. For example, the routing tag may include the same priority as in the original frame. Alternatively, the routing tag may include different information. For example, the routing tag may assign a new priority.

Modifications, additions, or omissions may be made to proxy server 30 without departing from the scope of the invention. The components of proxy server 30 may be integrated or separated according to particular needs. If any of the components are separated, components may be coupled using any suitable link. Moreover, the operations of proxy server 30 may be performed by more, fewer, or other modules. Additionally, operations of proxy server 30 may be performed using any suitable logic comprising software, hardware, other logic, or any suitable combination of the preceding.

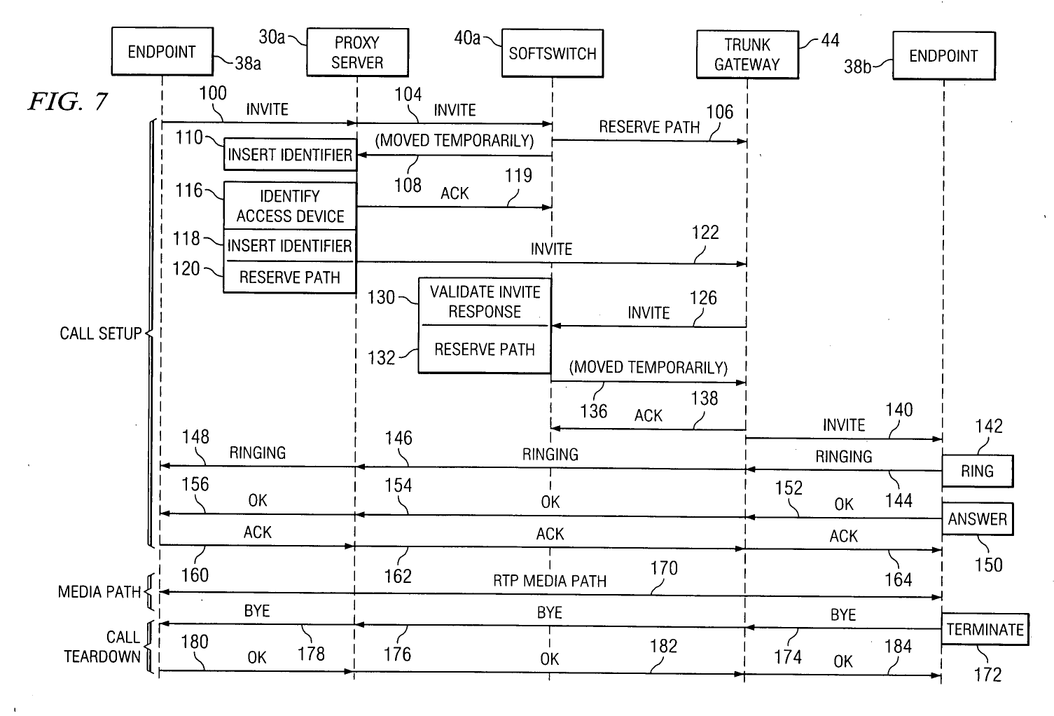

FIG. 7 is a call flow diagram illustrating an example method for routing packets from endpoint 38a to endpoint 38b using network 10 of FIG. 1. Steps 100 through 164 describe setting up a call. The method begins at step 100, where a caller endpoint 38a initiates a call to endpoint 38b by sending an invite request to proxy server 30a of node 28a. The invite request may be an invitation to initiate a call with endpoint 38b.

Proxy server 30a forwards the invite request to softswitch 40a, which operates an intermediate node 28 that can be used to set up a media path with endpoint 38b at step 104. An intermediate node 28 may refer to a node 28 that is associated with proxy server 30a. Softswitch 40a reserves a media path with trunk gateway 44 at step 106. According to one embodiment, the path may be a real-time transport protocol (RTP) path. Softswitch 40a sends a progress message to proxy server 30a at step 108. A progress message may refer to a progress indication that drives VoIP call states.

Proxy server 30a inserts the private network identifier for softswitch 40a into frames from endpoint 38a at step 110. Proxy server 30a may access a routing table to determine the private network identifier for softswitch 40a. For example, VLAN 102 may be determined to be the private network identifier for softswitch 40a. Proxy server 30a sends an acknowledgement to softswitch 40a at step 114.

Proxy server 30a identifies an access device 24 that can route the packets to endpoint 38b at step 116. Proxy server 30a may identify the access device 24 from a return IP address in the progress message received from softswitch 40a. For example, proxy server 30a may identify trunk gateway 44 as the access device 24. Proxy server 30a inserts the private network identifier of trunk gateway 44 into frames from endpoint 38a at step 118. Proxy server 30a may access a routing table to determine the private network identifier for trunk gateway 44. For example, VLAN 105 may be determined to be the private network identifier for trunk gateway 44. Proxy server 30a reserves the path to trunk gateway 44 at step 120.

Proxy server 30a sends an invite request to trunk gateway 44 at step 122. Trunk gateway 44 sends an invite response to softswitch 40a at step 126. Softswitch 40a validates the invite response at step 130. Softswitch 40a reserves the path at step 132 using the private network identifier of trunk gateway 44. For example, softswitch 40a may reserve the path using identifier VLAN 105. Softswitch 40a sends a progress message to trunk gateway 44 at step 136. Trunk gateway 44 sends an acknowledgement to softswitch 40a at step 138.

Trunk gateway 44 sends an invite request to endpoint 38b at step 140. The invite request may cause endpoint 38b to ring. Endpoint 38b rings at step 142. A progress message indicating that endpoint 38b is ringing is sent to endpoint 38a at steps 144, 146, and 148. Endpoint 38b answers the call at step 150. A progress message indicating that endpoint 38b has answered is sent to endpoint 38a at steps 152, 154, and 156. Endpoint 38a sends an acknowledgement to endpoint 38b at steps 160, 162, and 164.

A media path is established over the RTP channel at step 170. Endpoints 38a-b can communicate over the media path. Steps 172 through 184 describe tearing down the call. Endpoint 38b terminates the call at step 172. A progress message indicating that endpoint 38b has terminated the call is sent to endpoint a at steps 174, 176, and 178. Endpoint 38a sends acknowledgment at steps 180, 182, and 184. After the call is terminated, the method ends.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that a node of a ring may route Internet Protocol (IP) packets to another node of the ring. Accordingly, the ring does not need to use external IP resources to route the IP packets.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for routing frames in a communication ring, comprising:
receiving an invitation at a proxy server of a node of a ring, the ring comprising a plurality of nodes, each node operable to communicate with another node, the invitation indicating that a first endpoint is initiating a call to a second endpoint;
identifying an access device operable to communicate the call to the second endpoint, the access device in communication with the ring, the access device having a private network identifier uniquely identifying the access device within the ring;
reserving a media path to the access device; and
inserting the private network identifier into a plurality of frames received from the first endpoint in order to route the frames to the second endpoint through the media path.

2. The method of claim 1, wherein:
a node is operable to communicate with another node according to the Ethernet over Synchronous Optical Network (SONET) protocol; and
the plurality of frames comprise a plurality of media over Internet Protocol (IP) packets.

3. The method of claim 1, wherein identifying the access device operable to communicate the call to the second endpoint further comprises:
forwarding the invitation to an intermediate access device;
receiving a progress message from the intermediate access device, the progress message comprising an address corresponding to the access device; and
identifying the access device in accordance with the address.

4. The method of claim 1, wherein reserving the media path to the access device further comprises:
forwarding the invitation to an intermediate access device to initiate establishment of the media path;
receiving a progress message from the intermediate access device, the progress message comprising an address corresponding to the access device; and
reserving the path in response to receiving the progress message.

5. The method of claim 1, wherein the media path further comprises a real-time transport protocol (RTP) path.

6. The method of claim 1, further comprising determining the private network identifier associated with the access device according to a routing table.

7. An apparatus for routing frames in a communication ring, comprising:
an interface operable to receive an invitation at a proxy server of a node of a ring, the ring comprising a plurality of nodes, each node operable to communicate with another node, the invitation indicating that a first endpoint is initiating a call to a second endpoint; and
a routing module coupled to the interface and operable to:
identify an access device operable to communicate the call to the second endpoint, the access device in communication with the ring, the access device having a private network identifier uniquely identifying the access device within the ring;
reserve a media path to the access device; and
insert the private network identifier into a plurality of frames received from the first endpoint in order to route the frames to the second endpoint through the media path.

8. The apparatus of claim 7, wherein:
a node is operable to communicate with another node according to the Ethernet over Synchronous Optical Network (SONET) protocol; and
the plurality of frames comprise a plurality of media over Internet Protocol (IP) packets.

9. The apparatus of claim 7, wherein the routing module is operable to identify the access device operable to communicate the call to the second endpoint by:
forwarding the invitation to an intermediate access device;
receiving a progress message from the intermediate access device, the progress message comprising an address corresponding to the access device; and
identifying the access device in accordance with the address.

10. The apparatus of claim 7, wherein the routing module is operable to reserve the media path to the access device by:
forwarding the invitation to an intermediate access device to initiate establishment of the media path;
receiving a progress message from the intermediate access device, the progress message comprising an address corresponding to the access device; and
reserving the path in response to receiving the progress message.

11. The apparatus of claim 7, wherein the media path further comprises a real-time transport protocol (RTP) path.

12. The apparatus of claim 7, wherein the routing module is further operable to determine the private network identifier associated with the access device according to a routing table.

13. Logic for routing frames in a communication ring, the logic embodied in medium and operable to:
receive an invitation at a proxy server of a node of a ring, the ring comprising a plurality of nodes, each node operable to communicate with another node, the invitation indicating that a first endpoint is initiating a call to a second endpoint;
identify an access device operable to communicate the call to the second endpoint, the access device in communication with the ring, the access device having a private network identifier uniquely identifying the access device within the ring;
reserve a media path to the access device; and
insert the private network identifier into a plurality of frames received from the first endpoint in order to route the frames to the second endpoint through the media path.

14. The logic of claim 13, wherein:
a node is operable to communicate with another node according to the Ethernet over Synchronous Optical Network (SONET) protocol; and
the plurality of frames comprise a plurality of media over Internet Protocol (IP) packets.

15. The logic of claim 13, further operable to identify the access device operable to communicate the call to the second endpoint by:
forwarding the invitation to an intermediate access device;
receiving a progress message from the intermediate access device, the progress message comprising an address corresponding to the access device; and
identifying the access device in accordance with the address.

16. The logic of claim 13, further operable to reserve the media path to the access device by:
forwarding the invitation to an intermediate access device to initiate establishment of the media path;
receiving a progress message from the intermediate access device, the progress message comprising an address corresponding to the access device; and
reserving the path in response to receiving the progress message.

17. The logic of claim 13, wherein the media path further comprises a real-time transport protocol (RTP) path.

18. The logic of claim 13, further operable to determine the private network identifier associated with the access device according to a routing table.

19. A system for routing frames in a communication ring, comprising:
means for receiving an invitation at a proxy server of a node of a ring, the ring comprising a plurality of nodes, each node operable to communicate with another node, the invitation indicating that a first endpoint is initiating a call to a second endpoint;
means for identifying an access device operable to communicate the call to the second endpoint, the access device in communication with the ring, the access device having a private network identifier uniquely identifying the access device within the ring;
means for reserving a media path to the access device; and
means for inserting the private network identifier into a plurality of frames received from the first endpoint in order to route the frames to the second endpoint through the media path.

20. A method for routing frames in a communication ring, comprising:
receiving an invitation at a proxy server of a node of a ring, the ring comprising a plurality of nodes, each node operable to communicate with another node according to the Ethernet over Synchronous Optical Network (SONET) protocol, the invitation indicating that a first endpoint is initiating a call to a second endpoint;
identifying an access device operable to communicate the call to the second endpoint, the access device in communication with the ring, the access device having a private network identifier uniquely identifying the access device within the ring, the access device identified by:
forwarding the invitation to an intermediate access device;
receiving a progress message from the intermediate access device, the progress message comprising an address corresponding to the access device; and
identifying the access device in accordance with the address;
reserving a media path to the access device, the media path reserved in response to receiving the progress message, the media path further comprising a real-time transport protocol (RTP) path;
determining the private network identifier associated with the access device according to a routing table; and
inserting the private network identifier into a plurality of frames received from the first endpoint in order to route the frames to the second endpoint through the media path, the plurality of frames comprising a plurality of media over Internet Protocol (IP) packets.
